(19) United States
(12) Patent Application Publication
(10) Pub. No.: US 2025/0242686 A1
(43) Pub. Date: Jul. 31, 2025

(54) GRILLE SHUTTER DEVICE

(71) Applicant: TOYODA GOSEI CO., LTD., Kiyosu-shi (JP)

(72) Inventors: Shunsuke AOYAMA, Kiyosu-shi (JP); Yasuhiro KANEMOTO, Kiyosu-shi (JP)

(21) Appl. No.: 18/989,076

(22) Filed: Dec. 20, 2024

(30) Foreign Application Priority Data
Jan. 31, 2024 (JP) 2024-012466

(51) Int. Cl. B60K 11/08

(52) U.S. Cl. CPC B60K 11/085

(57) ABSTRACT

A grille shutter device includes a frame body having an inlet and airfoil-shaped flaps. The flaps are configured to open or close the inlet by rotating in forward and reverse directions around respective rotary shafts. A section of each flap between an upstream edge and a downstream edge is referred to as a first section. A section of each flap between the first section and the downstream edge is referred to as a second section. Each flap includes a symmetrical airfoil portion. The symmetrical airfoil portion is shaped to be symmetrical with respect to a chord line. A thickness of the symmetrical airfoil portion in a direction that is orthogonal to a direction in which the chord line extends and a direction in which the rotary shaft extends, gradually increases from the upstream edge toward the first section and gradually decreases from the first section toward the second section.

### CROSS-REFERENCE TO RELATED APPLICATIONS

This application is based upon and claims the benefit of priority from Japanese Patent Application No. 2024-012466, filed on Jan. 31, 2024, the entire contents of which are incorporated herein by reference.

### BACKGROUND

### 1. Field

The present disclosure relates to a grille shutter device.

### 2. Description of Related Art

Japanese Laid-Open Patent Publication No. 2019-104449 discloses a grille shutter device configured to open or close an opening provided at the front section of a vehicle. The grille shutter device includes fins, each having a rotary shaft extending in a vehicle width direction. The fins open or close the opening by rotating in forward and reverse directions around the rotary shafts.

Each fin includes a forward protrusion located in front of the rotary shaft when the opening is open, and a rearward protrusion located behind the rotary shaft. The front end of the forward protrusion includes a lower chamfered portion and an upper chamfered portion, both having an arcuate cross-section. The upper chamfered portion has a larger radius of curvature than the lower chamfered portion. This allows the air flowing from the front toward the fin to more easily flow toward the upper side of the fin.

In the grille shutter device disclosed in the publication, the air flowing toward the fins tends to flow more easily toward the upper side of the fins. As a result, a pressure difference in the air occurs between the upper and lower sides of the fins. Consequently, lift is generated on the fins, which may reduce the aerodynamic performance of the grille shutter device. These issues similarly arise even when the rotary shafts of the fins extend in the up-down direction.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A grille shutter device according to an aspect of the present disclosure is configured to open or close an opening provided at a front section of a vehicle. The grille shutter device includes a frame body having an inlet through which air flows and airfoil-shaped flaps, each having a rotary shaft that is rotationally supported by the frame body. The flaps are configured to open or close the inlet by rotating in forward and reverse directions around the respective rotary shafts. An edge of each of the flaps on an upstream side and an edge of each of the flaps on a downstream side in a flow direction of the air when the flaps are located in an open position, at which the flaps open the inlet, are referred to as an upstream edge and a downstream edge. A section of each of the flaps between the upstream edge and the downstream edge is referred to as a first section and a section of each of the flaps between the first section and the downstream edge is referred to as a second section. Each of the flaps includes a symmetrical airfoil portion that forms a portion of the flap between the upstream edge and the second section. The symmetrical airfoil portion is shaped to be symmetrical with respect to a chord line that connects the upstream edge to the downstream edge. A thickness of the symmetrical airfoil portion in a direction that is orthogonal to a direction in which the chord line extends and a direction in which the rotary shaft extends, gradually increases from the upstream edge toward the first section and gradually decreases from the first section toward the second section.

Other features and aspects will be apparent from the following detailed description, the drawings, and the claims.

### BRIEF DESCRIPTION OF THE DRAWINGS

FIG. 1 is a front view of a vehicle including a grille shutter device according to an embodiment.

FIG. 2 is an exploded perspective view of the grille shutter device shown in FIG. 1.

FIG. 3 is a plan view of the grille shutter device when the flaps are in the open position.

FIG. 4 is a plan view of the grille shutter device when the flaps are in the closed position.

FIG. 5 is a cross-sectional view showing the body of a flap shown in FIG. 2.

FIG. 6 is a cross-sectional view showing the state in which the bodies of the flaps, in the closed position, are in contact with each other.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

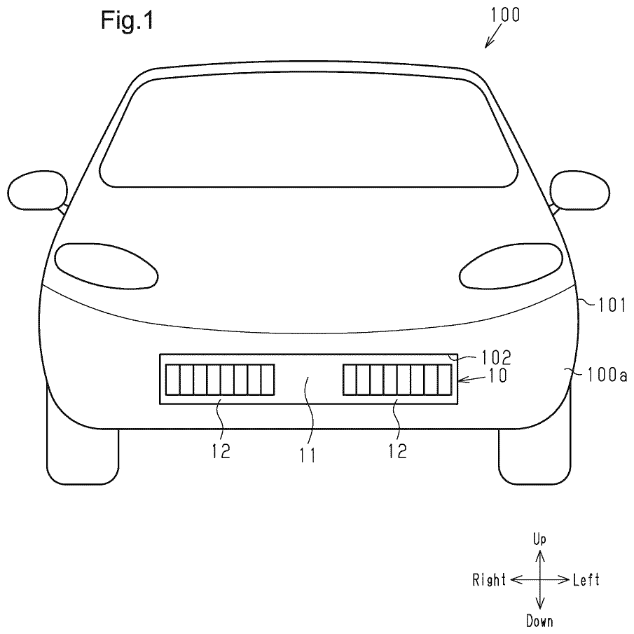

A grille shutter device 10 according to an embodiment will now be described with reference to FIGS. 1 to 6. In this specification, the term “symmetrical” is not limited to exact symmetry but also includes general symmetry within the scope that achieves the operation and advantages of the present embodiment. In this specification, the term “orthogonal” is not limited to exact orthogonality but also includes general orthogonality within the scope that achieves the operation and advantages of the present embodiment.

Hereinafter, the front side and the rear side in the front-rear direction of a vehicle 100, shown in FIG. 1, will be referred to as “front” and “rear,” respectively. Further, the right side and the left side in a vehicle width direction during the forward movement of the vehicle 100 will be referred to as “right” and “left,” respectively. Furthermore, the upper side and the lower side in the up-down direction of the vehicle 100 will be referred to as “upper” and “lower,” respectively.

### Grille Shutter Device 10

As shown in FIG. 1, the grille shutter device 10 is mounted in an opening 102 that is provided at a front section of the body 101 of the vehicle 100. The grille shutter device 10 allows or blocks the inflow of air into the body 101 through the opening 102 by opening or closing the opening 102. A radiator (not shown), for example, is located behind the opening 102 on the inner side of the body 101.

The front section of the vehicle 100 includes a design surface 100a that curves rearward as it extends outward from the center in the vehicle width direction. The grille shutter device 10 is part of the design surface 100a. The grille shutter device 10 extends along the design surface 100a, curving rearward as it extends outward from the center in the vehicle width direction.

The grille shutter device 10 includes a cover 11, and two shutters 12 respectively located on the opposite sides of the cover 11 in the vehicle width direction. The rear surface of the cover 11 is equipped with a device, such as a millimeter wave radar (not shown). The two shutters 12 have a symmetrical shape in the vehicle width direction.

Hereinafter, the components of the left one of the two shutters 12 will be described, and thus those of the right shutter 12 will not be described.

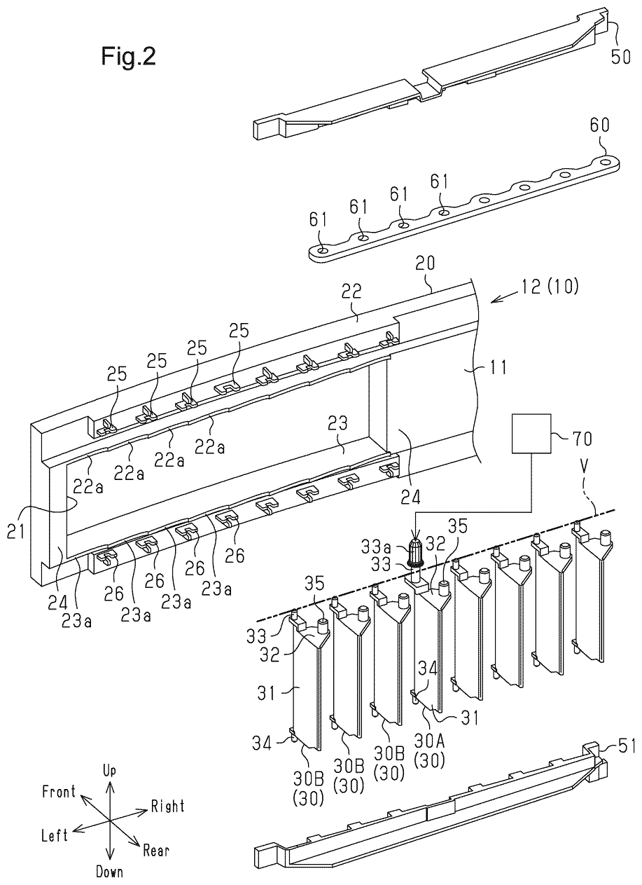

As shown in FIG. 2, the shutter 12 includes a frame body 20, flaps 30, an upper retainer 50, a lower retainer 51, a link 60, and an actuator 70. The frame body 20, each flap 30, the upper retainer 50, the lower retainer 51, and the link 60 are formed from resin material.

The frame body 20 is attached to the opening 102 (see FIG. 1) of the body 101. The flaps 30 are rotationally supported by the frame body 20. The upper retainer 50 and the lower retainer 51 restrict detachment of the flaps 30 supported by the frame body 20. The link 60 couples the flaps 30 to each other, thereby coordinating the rotation of the flaps 30 relative to the frame body 20. The actuator 70 rotates the flaps 30.

Each component of the shutter 12 will now be described in detail.

### Frame Body 20

The frame body 20 includes an inlet 21 into which air flows. The inlet 21 extends through the frame body 20 in the front-rear direction. The inlet 21 has a substantially rectangular shape elongated in the vehicle width direction.

The frame body 20 includes an upper frame portion 22 that defines the upper edge of the inlet 21, a lower frame portion 23 that defines the lower edge of the inlet 21, and two vertical frame portions 24 that respectively define the opposite side edges of the inlet 21. The two vertical frame portions 24 connect the ends of the upper frame portion 22 and the ends of the lower frame portion 23 to each other.

The front surface of a part of the frame body 20 that surrounds the inlet 21 curves rearward as it extends outward from the cover 11 in the vehicle width direction.

The upper frame portion 22 includes upper supports 25 that rotationally support upper rotary shafts 33 of the flaps 30, which will be described later, respectively. The upper supports 25 are spaced apart from each other in the longitudinal direction of the inlet 21. Each upper support 25 protrudes rearward from the rear surface of the upper frame portion 22. Each upper support 25 has a recess that opens rearward and rotationally accommodates a corresponding upper rotary shaft 33. The recess of each upper support 25 accommodates the upper rotary shaft 33 through the rear opening.

The lower frame portion 23 includes lower supports 26 that rotationally lower support rotary shafts 34 of the flaps 30, which will be described later, respectively. The lower supports 26 are spaced apart from each other in the longitudinal direction of the inlet 21. The lower supports 26 are located in correspondence with the upper supports 25. Each lower support 26 protrudes rearward from the rear surface of the lower frame portion 23. Each lower support 26 has a recess that opens rearward and rotationally accommodates a corresponding lower rotary shaft 34. The recess of each lower support 26 accommodates the lower rotary shaft 34 through the rear opening.

The part of the rear surface of the upper frame portion 22 that defines the upper edge of the inlet 21 includes upper notches 22a. The upper notches 22a are spaced apart from each other in the longitudinal direction of the inlet 21. The upper notches 22a are formed such that those located farther outward in the vehicle width direction are located farther rearward. Each upper notch 22a is shaped in conformance with the front surface of a symmetrical airfoil portion 45 of a corresponding flap 30 in the closed position, which will be described later.

The part of the rear surface of the lower frame portion 23 that defines the lower edge of the inlet 21 includes lower notches 23a. The lower notches 23a are spaced apart from each other in the longitudinal direction of the inlet 21. The lower notches 23a are formed such that those located farther outward in the vehicle width direction are located farther rearward. The lower notches 23a are located in correspondence with the upper notches 22a. Each lower notch 23a is shaped in conformance with the front surface of the symmetrical airfoil portion 45 of a corresponding flap 30 in the closed position, which will be described later.

### Flap 30

The flaps 30 are arranged in the longitudinal direction of the inlet 21. The flaps 30 include one driving flap 30A and driven flaps 30B. The shutter 12 includes, for example, seven driven flaps 30B. The driving flap 30A is located, for example, between three driven flaps 30B arranged in parallel and four driven flaps 30B arranged in parallel.

Each flap 30 includes a body 31, the upper rotary shaft 33, the lower rotary shaft 34, and a support shaft 35. The body 31, the upper rotary shaft 33, the lower rotary shaft 34, and the support shaft 35 are integrally formed in a seamless, continuous manner. The bodies 31 of the flaps 30 are identical in shape. The upper rotary shaft 33 of the driven flap 30B and the upper rotary shaft 33 of the driving flap 30A each have a different shape. The upper rotary shaft 33 and the lower rotary shaft 34 are each an example of a rotary shaft.

The body 31 has a plate shape with long sides extending in the up-down direction and short sides extending in a direction that is orthogonal to the long sides. The cross-sectional shape of the body 31, which is orthogonal to the up-down direction, is an airfoil shape. The cross-sectional shape of the body 31, which is orthogonal to the up-down direction, and the size of the cross-section are entirely uniform in the up-down direction.

The upper end of the body 31 has a projecting piece 32 that extends toward one side in the thickness direction of the body 31.

The upper rotary shaft 33 projects upward from the upper end of the body 31. The upper rotary shaft 33 is located at one end of the body 31 in the lateral direction. The lower rotary shaft 34 protrudes downward from the lower end of the body 31. The lower rotary shaft 34 is located at the one end of the body 31 in the lateral direction. The upper rotary shaft 33 and the lower rotary shaft 34 are located on the same axis, which extends in the up-down direction. The upper rotary shaft 33 and the lower rotary shaft 34 are rotationally supported by the upper support 25 and the lower support 26, respectively.

The flaps 30 are arranged on an imaginary axis V that extends straight such that those located farther outward in the vehicle width direction are located farther rearward. Specifically, the upper rotary shafts 33 and the lower rotary shafts 34 are arranged on the imaginary axis V. The flaps 30 are arranged at equal intervals along the imaginary axis V.

The tip of the upper rotary shaft 33 of the driving flap 30A has a gear 33a with teeth.

The support shaft 35 projects upward from a projecting end of the projecting piece 32 of the body 31. The support shaft 35 is located rearward from the upper rotary shaft 33.

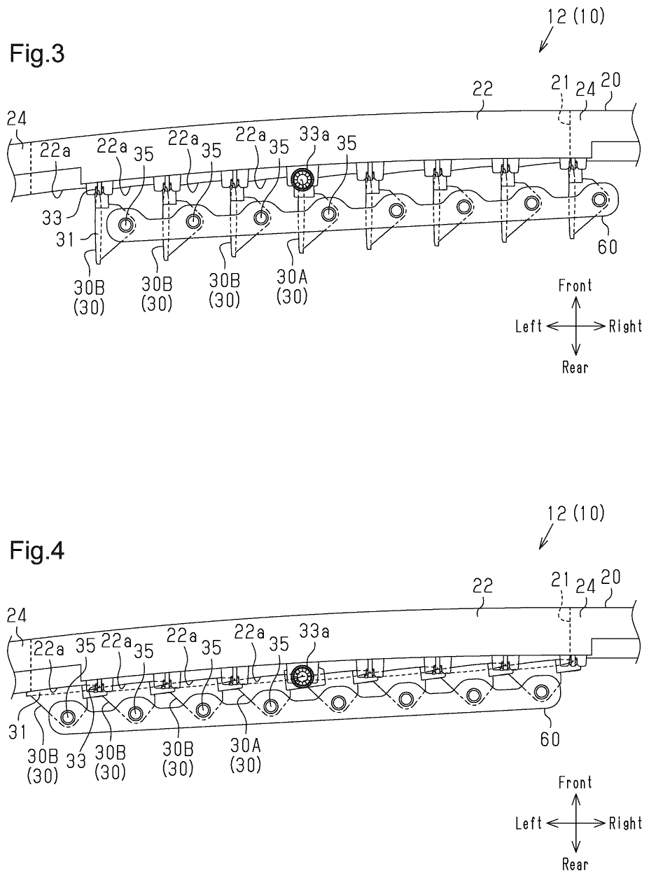

As shown in FIGS. 3 and 4, the flaps 30 open and close the inlet 21 by rotating around the respective upper rotary shafts 33 and the respective lower rotary shafts 34 between an open position, at which the inlet 21 is open, and a closed position, at which the inlet 21 is closed. In FIGS. 3 and 4, the upper retainer 50 and the lower retainer 51 are not shown.

As shown in FIG. 3, when the flaps 30 are in the open position, the lateral direction of the body 31 of each flap 30 coincides with the longitudinal direction of the vehicle 100.

As shown in FIG. 4, when the flaps 30 are in the closed position, the lateral direction of the body 31 of each flap 30 is inclined with respect to the vehicle width direction such that the body 31 is located farther rearward from the one end, where the upper rotary shaft 33 and the lower rotary shaft 34 are provided, toward the other end.

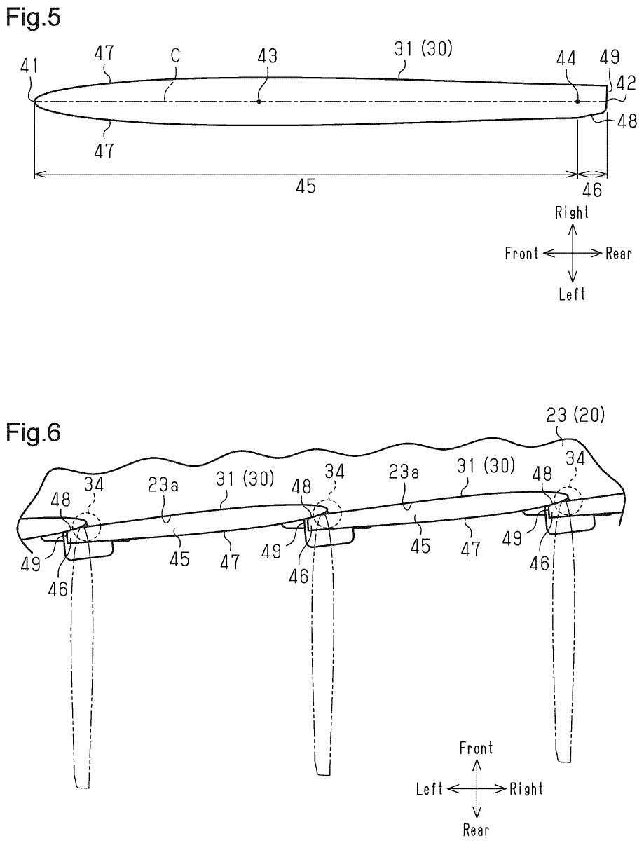

The shape of the body 31 of the flap 30 will now be described in detail with reference to FIGS. 5 and 6. In FIGS. 5 and 6, the hatching of the body 31 is omitted to facilitate understanding.

Hereinafter, the edge of the body 31 of each flap 30 on the upstream side and the edge of the body 31 of each flap 30 on the downstream side in the flow direction of air when the flaps 30 are located in the open position are referred to as the upstream edge 41 and the downstream edge 42, respectively. The virtual line connecting the upstream edge 41 to the downstream edge 42 is referred to as the chord line C. The direction orthogonal to the direction in which the chord line C extends and the up-down direction, in which the upper rotary shaft 33 and the lower rotary shaft 34 extend, is referred to as the thickness direction of the flap 30. The section of each flap 30 between the upstream edge 41 and the downstream edge 42 is referred to as the first section 43. The section of each flap 30 between the first section 43 and the downstream edge 42 is referred to as the second section 44. The first section 43 is located upstream of the midpoint of the chord line C. The second section 44 is located downstream of the midpoint of the chord line C between the first section 43 and the downstream edge 42.

The extending direction of the chord line C coincides with the lateral direction of the body 31. Thus, when the flap 30 is in the open position, the upstream edge 41 acts as the front edge of the body 31, while the downstream edge 42 acts as the rear edge of the body 31.

As shown in FIG. 5, the body 31 includes the symmetrical airfoil portion 45, which is shaped to be symmetrical with respect to the chord line C, and an asymmetrical airfoil portion 46, which is asymmetrical with respect to the chord line C. The symmetrical airfoil portion 45 forms a portion of the flap 30 between the upstream edge 41 and the second section 44. The asymmetrical airfoil portion 46 forms a portion of the flap 30 between the second section 44 and the downstream edge 42. Thus, the asymmetrical airfoil portion 46 is continuously formed downstream of the symmetrical airfoil portion 45. The second section 44 is the boundary between the symmetrical airfoil portion 45 and the asymmetrical airfoil portion 46.

To limit a decrease in the aerodynamic performance of the flap 30, it is preferred that the proportion of the asymmetrical airfoil portion 46 occupying the body 31 be relatively small. In the present embodiment, the proportion of the asymmetrical airfoil portion 46 occupying the body 31 is set to about 5% or less.

The thickness of the symmetrical airfoil portion 45 gradually increases from the upstream edge 41 toward the first section 43 and gradually decreases from the first section 43 toward the second section 44. That is, the first section 43 is the section where the thickness is greatest in the symmetrical airfoil portion 45. The portion of the flap 30 located upstream of the first section 43 tapers with an arcuate tip.

Two curved surfaces 47 protruding in a direction away from the chord line C are provided on the opposite sides of the symmetrical airfoil portion 45 in the thickness direction, respectively. The two curved surfaces 47 have a streamlined shape. The two curved surfaces 47 extend away from each other in the thickness direction as they progress from the upstream edge 41 toward the first section 43, and extend closer to each other in the thickness direction as they progress from the first section 43 toward the second section 44. Each curved surface 47 is farthest from the chord line C in the first section 43. The portion of each curved surface 47 located downstream of the first section 43 is more gently curved than the portion upstream of the first section 43.

The thickness of the asymmetrical airfoil portion 46 gradually decreases from the second section 44 toward the downstream edge 42.

As shown in FIG. 6, the asymmetrical airfoil portion 46 includes a contact surface 48 on one side in the thickness direction. When the flaps 30 are in the closed position, the contact surface 48 of each flap 30 is in contact with the outer surface of the symmetrical airfoil portion 45 of another flap 30. The contact surface 48 is formed on the outer surface of the asymmetrical airfoil portion 46 on the front side in a direction in which the flap 30 rotates from the open position to the closed position. The contact surface 48 of each flap 30 is curved along the curved surface 47 of another flap 30 such that the contact surface 48 approaches the chord line C as it extends downstream. The contact surface 48 of each flap 30 makes surface contact, from behind, with the curved surface 47 of the other flap 30. The contact surface 48 is formed over the entire body 31 in the up-down direction. The curved surface 47, the contact surface 48, and a downstream end face 49 are continuous with each other.

As shown in FIG. 5, the outer surface of the asymmetrical airfoil portion 46 in the thickness direction on the opposite side of the contact surface 48 is curved with the same curvature as the curved surface 47 of the portion of the symmetrical airfoil portion 45 downstream of the first section 43.

The downstream edge 42 includes the downstream end face 49, which is planar and orthogonal to the chord line C. The cross-sectional shape of the body 31 is also a Kamm tail shape, where the downstream end of a symmetrical airfoil is truncated. In the cross-sectional shape of the body 31 in the present embodiment, the downstream end of a NACA 0006 airfoil profile is truncated and the contact surface 48 is formed. Thus, the cross-sectional shape of the symmetrical airfoil portion 45 is the same as that of part of the NACA 0006 airfoil profile.

As shown in FIGS. 4 and 6, the flaps 30 located in the closed position are arranged such that the front surfaces of the flaps 30 exposed from the inlet 21 are arranged along the front surfaces of the upper frame portion 22 and the lower frame portion 23. When the flaps 30 are located in the closed position, the end of one body 31 on one side in the lateral direction, where the upper rotary shaft 33 and lower rotary shaft 34 are provided, overlaps the opposite end of another body 31 on the other side from behind. Specifically, the contact surface 48 of the one body 31 is in contact from behind with the curved surface 47 of the other body 31. In this state, one end of the body 31 of the flap 30, which is located in the innermost position in the vehicle width direction, overlaps the vertical frame portion 24, which is located on the inner side in the vehicle width direction, from behind. The other end of the body 31 of the flap 30, which is located in the outermost position in the vehicle width direction, overlaps the vertical frame portion 24, which is located on the outer side in the vehicle width direction, from behind.

The front surface of the body 31 of each flap 30 in the closed position is in contact with the rear surface of the upper frame portion 22 and the lower frame portion 23. Specifically, the front surface of the symmetrical airfoil portion 45 of each flap 30 in the closed position is in contact with the inner surface of the upper notch 22a and the inner surface of the lower notch 23a. In this state, the asymmetrical airfoil portion 46 of each flap 30 is not in contact with the inner surface of the upper notch 22a or the inner surface of the lower notch 23a.

### Upper Retainer 50 and Lower Retainer 51

As shown in FIG. 2, the upper retainer 50 and the lower retainer 51 have an elongated shape extending in the longitudinal direction of the inlet 21.

The upper retainer 50 is attached to the upper frame portion 22 so as to cover the recesses of all the upper supports 25 from behind. This restricts detachment of the upper rotary shafts 33, which are respectively accommodated in the recesses of the upper supports 25.

The lower retainer 51 is attached to the lower frame portion 23 so as to cover the recesses of all the lower supports 26 from behind. This restricts detachment of the lower rotary shafts 34, which are respectively accommodated in the recesses of the lower supports 26.

### Link 60

The link 60 has an elongated plate shape extending in the longitudinal direction of the inlet 21. The link 60 includes support holes 61 that rotationally support the support shafts 35 of the flaps 30, respectively. The support holes 61 are spaced apart from each other in the longitudinal direction of the link 60. The support holes 61 are arranged along the above-described imaginary axis V.

The link 60 transmits power, acting on the driving flap 30A through the actuator 70, to each driven flap 30B. As a result, as the driving flap 30A rotates, each driven flap 30B rotates.

### Actuator 70

The actuator 70 is, for example, a motor with an output shaft that is configured to rotate in forward and reverse directions.

The actuator 70 is mounted on, for example, the upper retainer 50. The output shaft of the actuator 70 is connected to the gear 33a of the driving flap 30A. The power of the actuator 70 is transmitted to the driving flap 30A through the gear 33a, causing the driving flap 30A to rotate in the forward and reverse directions.

### Operation of Present Embodiment

The thickness of the symmetrical airfoil portion 45 of each flap 30 gradually increases from the upstream edge 41 toward the first section 43 and gradually decreases from the first section 43 toward the second section 44. This configuration reduces the pressure difference in the flow of air flowing along the opposite sides, in the thickness direction, of the flap 30 in the open position. This configuration also limits an increase in the air resistance that results from the shape of the flap 30.

### Advantages of Present Embodiment

(1) Each flap 30 includes the symmetrical airfoil portion 45, which forms a portion of the flap 30 between the upstream edge 41 and the second section 44. The thickness of the symmetrical airfoil portion 45 gradually increases from the upstream edge 41 toward the first section 43 and gradually decreases from the first section 43 toward the second section 44.

This configuration produces the above-described operation and limits a decrease in the aerodynamic performance of the grille shutter device 10.

Further, an increase in air resistance of the flap 30 is limited. Thus, when the flaps 30 are in the open position, it facilitates the flow of air into the body 101 through the opening 102. Thus, for example, the cooling efficiency of a device such as a radiator installed in the vehicle 100 is improved.

(2) The downstream edge 42 includes the downstream end face 49, which is planar and orthogonal to the chord line C.

In symmetrical airfoils that are symmetrical relative to the chord line C, it is known that there is only a slight difference in aerodynamic performance between a configuration having a tapered section at the downstream edge and a configuration having an end face in which the tip of this section is truncated and having a planar end face that is orthogonal to the chord line C.

In the above-described configuration, the downstream edge 42 of the flap 30 includes the downstream end face 49, which is planar and orthogonal to the chord line C. This limits an increase in the size of the flap 30 in the direction in which the chord line C extends, while reducing the pressure difference in the flow of air flowing along the opposite sides, in the thickness direction, of the flap 30 in the open position.

Additionally, if the flap 30 is made of resin and has a section tapered toward the downstream edge 42, the thickness of this section decreases. As a result, molding the flap 30 may be difficult.

In the above-described configuration, the downstream end face 49 is formed on the downstream edge 42 of the flap 30. Thus, an excessive decrease in the thickness of the flap 30 is limited. This allows the resin flap 30 to be molded more easily.

(3) The asymmetrical airfoil portion 46 includes the contact surface 48. When the flaps 30 are in the closed position to close the inlet 21, the contact surface 48 of each flap 30 is in contact with the curved surface 47 of the symmetrical airfoil portion 45 of another flap 30.

In this configuration, the contact surface 48 of the asymmetrical airfoil portion 46 of each flap 30 is in contact with the curved surface 47 of the symmetrical airfoil portion 45 of another flap 30. This reduces the gap between these flaps 30, which are in contact with each other. Thus, an increase in the air resistance caused by the air flowing into the gap between the flaps 30 located in the closed position is limited. Accordingly, a decrease in the aerodynamic performance of the grille shutter device 10 when the flaps 30 are located in the closed position is limited.

(4) The contact surface 48 of each flap 30 is curved along the curved surface 47 of another flap 30.

In this configuration, the contact surface 48 of each flap 30 is curved along the curved surface 47 of another flap 30. Thus, the gap between these flaps 30, which are in contact with each other, is further reduced. Accordingly, a decrease in the aerodynamic performance of the grille shutter device 10 when the flaps 30 are located in the closed position is further limited.

### Modifications

The present embodiment may be modified as follows. The present embodiment and the following modifications can be combined as long as the combined modifications remain technically consistent with each other.

The contact surface 48 does not need to be curved. The contact surface 48 may be a planar, inclined surface that is inclined with respect to the chord line C. In this case, the outer surfaces of the symmetrical airfoil portion 45 on the opposite sides in the thickness direction may be the curved surfaces 47 or may be outer surfaces shaped along the contact surface 48.

The asymmetrical airfoil portion 46 does not need to include the contact surface 48. In this case, the symmetrical airfoil portion 45 may define a portion between the upstream edge 41 and the downstream edge 42, where the downstream end face 49 is formed. That is, the entire body 31 may be the symmetrical airfoil portion 45.

The flaps 30 located in the closed position do not have to be in contact with each other.

The downstream end face 49 may be flat and slightly inclined with respect to the thickness direction of the flap 30.

The downstream edge 42 of the flap 30 does not need to include the downstream end face 49. In this case, the flap 30 may have a tapered section at the downstream end. Further, in this case, the contact surface 48 may be located upstream of the tip of the tapered section of the flap 30.

The flap 30 may be formed from a metal material.

The upper rotary shaft 33 and the lower rotary shaft 34 may be provided between one end and the other end of the body 31 in the lateral direction.

The flap 30 may include a rotary shaft extending in the vehicle width direction, instead of the upper rotary shaft 33 and the lower rotary shaft 34. It is preferred that the rotary shaft, for example, be rotationally supported by the two vertical frame portions 24.

The grille shutter device 10 does not need to be part of the design surface 100a of the vehicle 100. The grille shutter device 10 may be located behind the design surface 100a in the opening 102 as long as the opening 102 can be opened or closed.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A grille shutter device configured to open or close an opening provided at a front section of a vehicle, the grille shutter device comprising:
a frame body having an inlet through which air flows; and
airfoil-shaped flaps, each having a rotary shaft that is rotationally supported by the frame body, the flaps being configured to open or close the inlet by rotating in forward and reverse directions around the respective rotary shafts, wherein
an edge of each of the flaps on an upstream side and an edge of each of the flaps on a downstream side in a flow direction of the air when the flaps are located in an open position, at which the flaps open the inlet, are referred to as an upstream edge and a downstream edge,
a section of each of the flaps between the upstream edge and the downstream edge is referred to as a first section and a section of each of the flaps between the first section and the downstream edge is referred to as a second section,
each of the flaps includes a symmetrical airfoil portion that forms a portion of the flap between the upstream edge and the second section,
the symmetrical airfoil portion is shaped to be symmetrical with respect to a chord line that connects the upstream edge to the downstream edge, and
a thickness of the symmetrical airfoil portion in a direction that is orthogonal to a direction in which the chord line extends and a direction in which the rotary shaft extends, gradually increases from the upstream edge toward the first section and gradually decreases from the first section toward the second section.

2. The grille shutter device according to claim 1, wherein
the downstream edge has a planar downstream end face that is orthogonal to the chord line.

3. The grille shutter device according to claim 1, wherein
the flaps each include an asymmetrical airfoil portion that is continuously formed downstream of the symmetrical airfoil portion and is asymmetrical in shape relative to the chord line, and
the asymmetrical airfoil portion includes a contact surface, wherein, when the flaps are in the closed position to close the inlet, the contact surface of each of the flaps is in contact with an outer surface of the symmetrical airfoil portion of an other one of the flaps.

4. The grille shutter device according to claim 3, wherein
two curved surfaces protruding in a direction away from the chord line are respectively provided on opposite sides of the symmetrical airfoil portion in a thickness direction of the symmetrical airfoil portion, and
the contact surface of each of the flaps is curved along the curved surface of the other one of the flaps.
